(19) United States
(12) Patent Application Publication
(10) Pub. No.: US 2023/0043659 A1
(43) Pub. Date: Feb. 9, 2023

(54) MOTOR UNIT AND POWER-ASSISTED BICYCLE

(71) Applicant: Panasonic Intellectual Property Management Co., Ltd., Osaka (JP)

(72) Inventors: Shigeru IDO, Osaka (JP); Masafumi KAWAKAMI, Nara (JP); Takanori NAKANO, Nara (JP)

(21) Appl. No.: 17/816,768

(22) Filed: Aug. 2, 2022

(30) Foreign Application Priority Data
Aug. 4, 2021 (JP) 2021-128532

(51) Int. Cl. H02K 11/33; H02K 11/215; B62M 6/50; B62J 45/42; B62J 45/20

(52) U.S. Cl. CPC H02K 11/33; H02K 11/215; B62M 6/50; B62J 45/42; B62J 45/20; H02K 2211/03

(57) ABSTRACT

A motor unit, which is an example of an embodiment, includes a motor including a motor shaft, a rotor fixed to the motor shaft, and a stator, and a control board, the control board being disposed with at least a part of the control board overlapping the motor when viewed in a motor axial direction. A sensor that detects a magnetic field of the motor shaft, the rotor, or a rotating body rotating together with the motor shaft, and a control element that controls the motor using detection information of the sensor, are mounted on the control board. The control board includes a signal line that connects the sensor and the control element. The signal line includes an arcuate wiring section bent to be convex in a radial direction outer side of a circle centering on a shaft core of the motor shaft.

### CROSS REFERENCE TO RELATED APPLICATION

The entire disclosure of Japanese Patent Application No. 2021-128532 filed on Aug. 4, 2021 including the specification, claims, drawings, and abstract, is incorporated herein by reference in its entirety.

### TECHNICAL FIELD

The present disclosure relates to a motor unit and a power-assisted bicycle including the motor unit.

### BACKGROUND

There has been widely known a power-assisted bicycle that includes a motor unit including a motor and a control board, and that assists a stepping force on a pedal by a user with power of the motor (see, for example, JP 2011-168180 A (Patent Literature 1)). In general, a sensor such as a Hall element that detects a magnetic field of a rotating body rotating together with a motor shaft, and a microcomputer that performs arithmetic processing using detection information and the like of the sensor and controls the motor, are mounted on the control board of the motor unit. The control board includes a signal line that connects the sensor and the microcomputer.

### SUMMARY

Incidentally, the Hall element mounted on the control board is disposed near the motor. Accordingly, in some cases, noise occurs in the signal line connecting the Hall element and the microcomputer and deteriorates controllability of the motor because of the influence of a leakage flux that occurs from the motor.

An advantage of the present disclosure is to provide a motor unit capable of reducing the influence of a leakage flux of a motor and suppressing noise that occurs in a signal line of a control board.

A motor unit according to the present disclosure includes: a motor including a motor shaft, a rotor fixed to the motor shaft, and a stator; and a control board on which a sensor that detects a magnetic field of the motor shaft, the rotor, or a rotating body rotating together with the motor shaft, and a control element that controls the motor using detection information of the sensor, are mounted, the control board being disposed with at least a part of the control board overlapping the motor when viewed in a motor axial direction. The sensor is disposed to overlap the rotor when viewed in the motor axial direction. The control element is disposed further out in a radial direction of the motor than an inner circumferential edge of the stator surrounding the rotor. The control board includes a signal line that connects the sensor and the control element. When the control board is viewed in the motor axial direction, the signal line traverses a gap formed between the rotor and the stator such that a first imaginary line connecting a first point where the signal line overlaps an outer circumferential edge of the rotor, and a second point where the signal line overlaps the inner circumferential edge of the stator, has an angle of 45° or less with respect to a second imaginary line passing through the first point and the shaft core of the motor shaft.

A power-assisted bicycle according to the present disclosure includes the motor unit described above.

With the motor unit according to the present disclosure, it is possible to reduce the influence of a leakage flux of the motor and suppress noise that occurs in the signal lines of the control board. The power-assisted bicycle including the motor unit according to the present disclosure, for example, has excellent controllability of the motor, and has a satisfactory assist function.

### BRIEF DESCRIPTION OF DRAWINGS

An embodiment of the present disclosure will be described based on the following figures, wherein:

FIG. 1 is a diagram showing the exterior of a power-assisted bicycle, which is an example of an embodiment;

FIG. 2 is a sectional view of a motor unit;

FIG. 3 is a right side view of the motor unit and is a diagram showing a state in which a second divided body of a case is removed;

FIG. 4 is a diagram showing a first surface of a control board;

FIG. 5 is a diagram showing a second surface of the control board;

FIG. 6 is a diagram for describing a configuration of signal lines for a Hall element of the control board; and

FIGS. 7A and 7B are diagrams for describing the configuration of the signal lines for the Hall element of the control board.

### DESCRIPTION OF EMBODIMENTS

An embodiment of a motor unit and a power-assisted bicycle according to the present disclosure will be described in detail below with reference to the drawings. The embodiment described below is only an example. The present disclosure is not limited to the embodiment described below. Forms obtained by selectively combining a plurality of embodiments and modifications described below are included in the present disclosure.

The motor unit according to the present disclosure is suitable for the power-assisted bicycle. In this embodiment, a power-assisted bicycle 1 is illustrated as an application target. However, the motor unit can also be applied to electric vehicles such as an electric automobile and an electric motorcycle, and electric equipment other than vehicles.

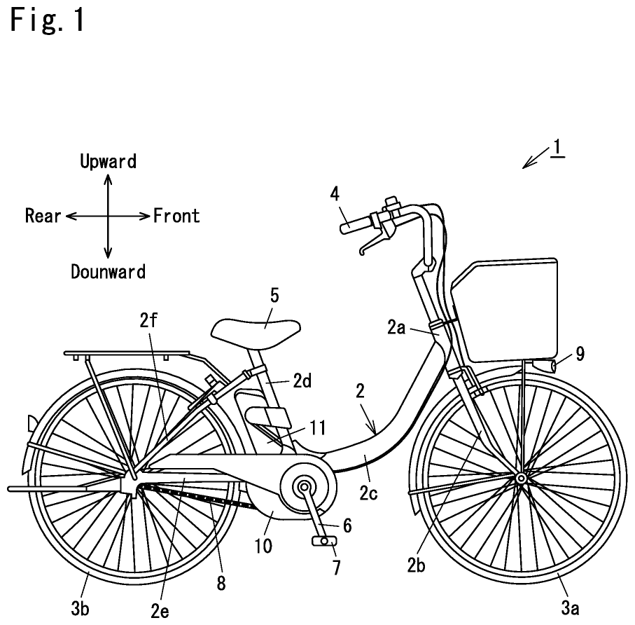

FIG. 1 is a diagram showing the exterior of the power-assisted bicycle 1, which is an example of the embodiment. Note that the power-assisted bicycle of the present disclosure is not limited to a city bike illustrated in FIG. 1 and may be, for example, a sport bike or a foldable bicycle. In the following explanation, for convenience of explanation, terms indicating up, down, left, and right directions are used. However, the front, rear, up, down, left, and right of the power-assisted bicycle 1 and components mean front, rear, up, down, left, and right in a normal state of use.

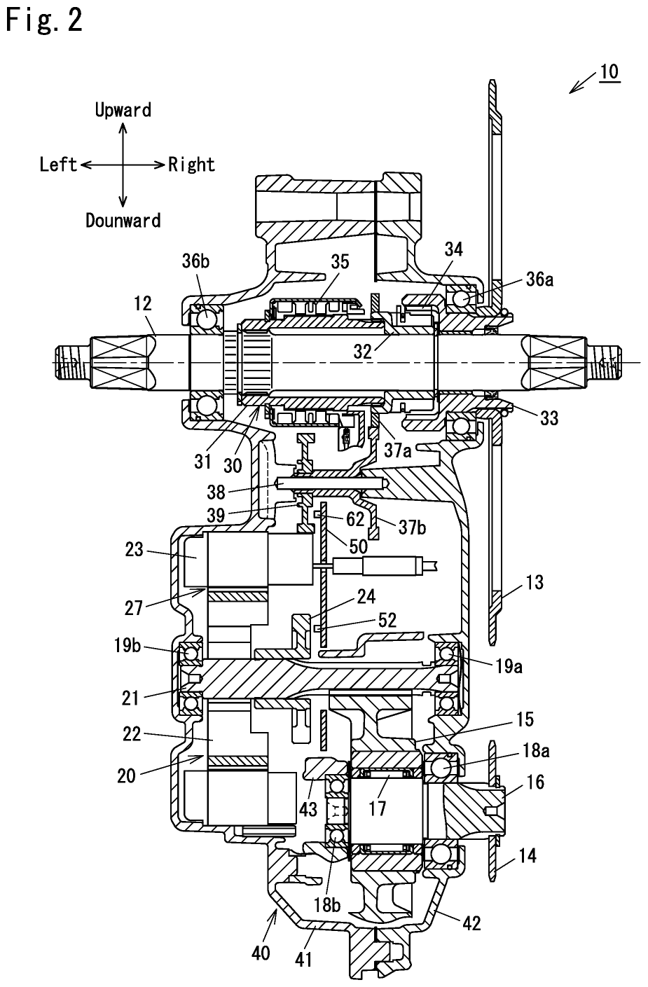

As shown in FIG. 1, the power-assisted bicycle 1 includes a motor unit 10 and a battery 11 that supplies electric power to the motor unit 10. Like a general bicycle, the power-assisted bicycle 1 includes a frame 2, a front wheel 3a, a rear wheel 3b, a handlebar 4, a saddle 5, crankarms 6, pedals 7, a chain 8, and a headlight 9. The crankarms 6 and the pedals 7 attached to one end portions of the crankarms 6 are provided one each on the left and the right of the power-assisted bicycle 1. The other end portions of the left and right crankarms 6 are fixed to a crankshaft 12 (see FIG. 2 and the like referred to below).

The power-assisted bicycle 1 is a bicycle that assists a stepping force on the pedals 7 by a user with power of a motor 20 (see FIG. 2 and the like referred to below). In this embodiment, the stepping force on the pedals 7 and an output of the motor 20 are transmitted to the rear wheel 3b via the chain 8. The power-assisted bicycle 1 includes a sprocket 13 (see FIG. 2 and the like referred to below) that rotates according to rotation of the pedals 7 and a rear wheel sprocket (not shown) provided in the rear wheel 3b. The sprocket 13 and the rear wheel sprocket are coupled via the chain 8.

The frame 2 is a framework that couples the front wheel 3a, the rear wheel 3b, the handlebar 4, the saddle 5, and the like. The motor unit 10 and the battery 11 are supported by the frame 2. The frame 2 is configured by a plurality of pipes. In this embodiment, a head pipe 2a, a front fork 2b, a down pipe 2c, a seat pipe 2d, chain stays 2e, seat stays 2f, and a bottom bracket (not shown) are provided as the plurality of pipes. The bottom bracket is a pipe that connects the down pipe 2c, the seat pipe 2d, and the chain stays 2e.

The head pipe 2a supports the front fork 2b and the handlebar 4 in a state in which the front fork 2b and the handlebar 4 are rotatable around the center axis of the head pipe 2a. The front fork 2b includes a pair of legs that rotatably support the front wheel 3a and a steering column that extends upward from the upper end portions of the legs, and that is inserted into a tube of the head pipe 2a. The handlebar 4 is attached to the upper end portion of the steering column.

The down pipe 2c is a pipe that connects the head pipe 2a and the bottom bracket. The down pipe 2c is inclined to be located further upward toward the front of the power-assisted bicycle 1. The seat pipe 2d is a pipe that holds the saddle 5. The seat pipe 2d is inclined with respect to the up-down direction such that the upper end of the seat pipe 2d is located further to the rear of the power-assisted bicycle 1 than the lower end of the seat pipe 2d. In this embodiment, the battery 11 is attached to the seat pipe 2d. The motor unit 10 is attached to the bottom bracket.

The chain stays 2e are pipes that connect the seat stays 2f and the bottom bracket. The chain stays 2e are provided one each on the left and the right, to extend from the rear end portion of the bottom bracket to the rear of the bicycle and sandwich the rear wheel 3b from both sides. Like the chain stays 2e, the seat stays 2f are provided one each on the left and the right to sandwich the rear wheel 3b from both sides. The left and right seat stays 2f extend from an upper part of the seat pipe 2d to the radial direction center of the rear wheel 3b, and are coupled to the left and right chain stays 2e in the center in a one to one relation. The rear wheel 3b is rotatably fixed to the rear end portions of the chain stays 2e.

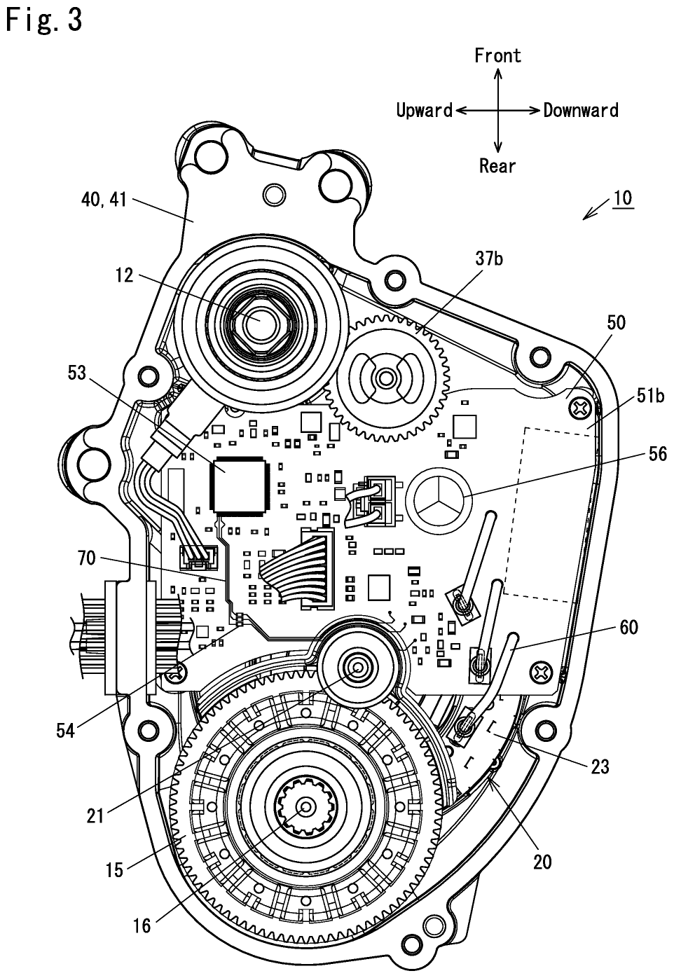

A configuration of the motor unit 10, which is an example of the embodiment, is described in detail below with reference to FIGS. 2 and 3.

As shown in FIGS. 2 and 3, the motor unit 10 includes a motor 20, a crankshaft unit 30 including the crankshaft 12, and a case 40 that houses the motor 20 and the crankshaft unit 30. The motor unit 10 is a driving unit that assists a stepping force on the pedals 7. For example, an output of the motor 20 is controlled based on torque (a stepping force) acting on the crankshaft 12 coupling the pair of crankarms 6 (see FIG. 1), and vehicle speed. The output of the motor 20 may be controlled using the rotating speed of the crankshaft 12. Both sides of the crankshaft 12 in the axial direction extend to the left and the right from the inside of the case 40. The sprocket 13 is fixed to the axial direction right side portion of the crankshaft 12 via an output body 33.

In the motor unit 10, a second sprocket 14 attached to an output shaft 16 is provided. The rear wheel sprocket is coupled to the sprockets 13 and 14 via the chain 8. The output shaft 16 is a rotating shaft for outputting power of the motor 20 and is connected to a motor shaft 21 of the motor 20 via a speed reducing mechanism 15. Note that the output shaft 16 is a rotating shaft of a gear of the speed reducing mechanism 15. The gear of the speed reducing mechanism 15 is attached to the output shaft 16 via a one-way clutch 17. The motor unit 10 is a biaxial motor unit in which power of the motor 20 is output from the output shaft 16. However, the configuration of the present disclosure is applicable to a uniaxial motor unit as well.

The motor unit 10 further includes a control board 50 for controlling an output of the motor 20 and realizing an appropriate power assist function. The control board 50 includes a substrate 51 and various electronic components mounted on the substrate 51. The control board 50 is disposed with at least a part of the control board 50 overlapping the motor 20 when viewed in the motor axial direction, and is housed in the case 40 together with the motor 20. As described in detail below, a sensor that detects a magnetic field of the motor shaft 21, a rotor 22, or a rotating body that rotates together with the motor shaft 21, and a microcomputer 53 that controls the motor 20 using detection information of the sensor, are mounted on the control board 50. A preferred example of the sensor is a Hall element 52.

The motor 20 includes the motor shaft 21, the rotor 22 fixed to the motor shaft 21, and a stator 23. The motor 20 is an inner rotor type in which the stator 23 having an annular shape is disposed to surround the rotor 22. However, the motor 20 may be an outer rotor type in which a rotor is disposed on the outer side of a stator. The motor 20 is disposed in the case 40 such that the motor shaft 21 extends in the left-right direction. Note that in this specification, the “motor axial direction” means a direction extending along the motor shaft 21.

The motor shaft 21 is rotatably supported by bearings 19a and 19b. The rotor 22 is fixed to one end, in the axial direction, of the motor shaft 21. An engagement groove that meshes with a gear of the speed reducing mechanism 15 is formed on another end in the axial direction. In this embodiment, a rotating body 24 is fixed between the rotor 22 of the motor shaft 21 and the engagement groove. The rotating body 24 includes a permanent magnet and functions as a section to be detected by the Hall element 52. Since the rotating body 24 rotates together with the motor shaft 21 and the rotor 22, the Hall element 52 can detect the position of the rotor 22 by detecting a magnetic field of the rotating body 24.

The rotor 22 is a rotor that rotates together with the motor shaft 21. The rotor 22 is disposed in the radial direction center of the motor 20 surrounded by the stator 23. The rotor 22 includes, for example, a rotor core fixed to the motor shaft 21 and a plurality of permanent magnets embedded in the rotor core, and forms a rotor magnetic pole. The rotor core is a stacked body obtained by stacking a plurality of annular magnetic thin plates in the motor axial direction. Note that a predetermined gap 27 is formed between the outer circumferential surface of the rotor 22 and the inner circumferential surface of the stator 23.

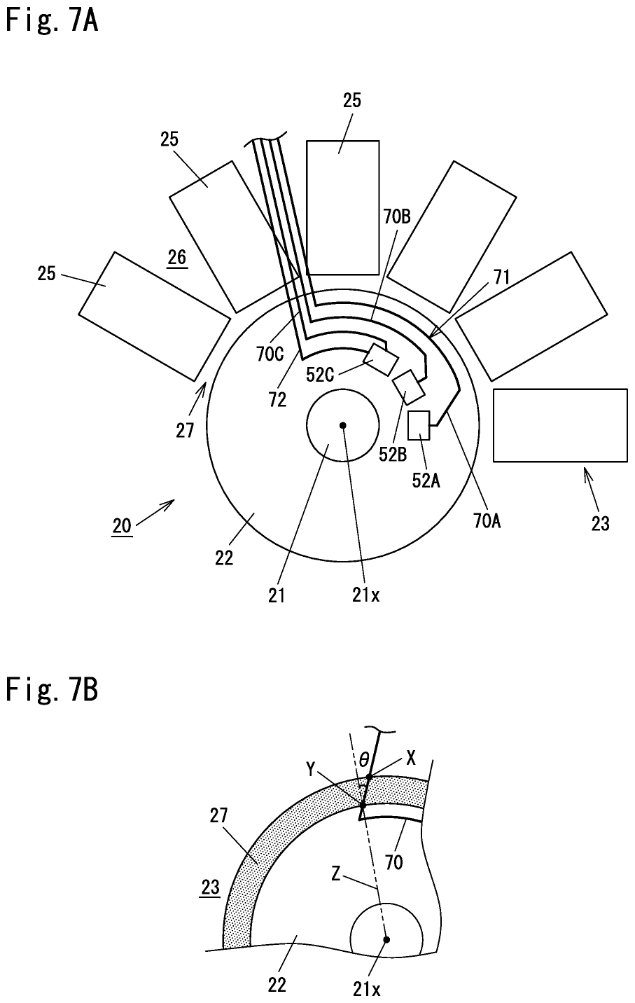

The stator 23 is a stator fixed to the case 40 and is configured by a stator core and a coil. The stator core includes, for example, an annular back yoke and a plurality of teeth 25 (see FIG. 7 referred to below) extending to the radial direction inner side from the yoke. Note that a gap between the teeth 25 that are adjacent to each other in the motor circumferential direction is called a slot 26. The coil is configured by a winding wire wound on the teeth 25. A method of winding the winding wire may be either concentrated winding for winding the winding wire on one tooth 25, or distributed winding for winding the winding wire across a plurality of teeth 25.

The motor 20 only has to be a motor capable of assisting traveling of the power-assisted bicycle 1. A preferred example of the motor 20 is a three-phase motor including three-phase coils of a U phase, a V phase, and a W phase. Examples of a preferred three-phase motor include a three-phase brushless DC motor. In the motor 20, a rotating magnetic flux component generated by the stator 23 and a magnetic flux component generated by the rotor 22 synchronize to generate rotation torque. Magnetic fluxes are generated between the rotor 22 and the stator 23, from the rotor 22 toward the teeth 25, and from the teeth 25 toward the rotor 22. However, the directions of the magnetic fluxes are opposite, for example, between the teeth 25 that are adjacent to each other in the motor circumferential direction. In the case of the three-phase motor, strictly speaking, directions of vectors of magnetic fluxes are opposite in three teeth 25 adjacent to one another in the motor circumferential direction.

Note that a leakage flux that does not contribute to rotation torque occurs from the motor 20. A magnetic flux leaking from between the rotor 22 and the stator 23 reaches the control board 50 disposed to overlap the rotor 22 in the motor axial direction and causes magnetic field noise in electronic components and wires of a control system. As described in detail below, the control board 50 is configured to be able to reduce the influence of the leakage flux, and sufficiently suppress such magnetic field noise. Note that the leakage flux particularly easily occurs in the gap 27 formed between the rotor 22 and the stator 23.

In this embodiment, a maximum value of a driving current of the motor 20 is 15 A or more, and is preferably 25 A or more. An upper limit of the driving current is, for example, 50 A. A maximum value of output torque of the motor 20 is 75 N·m or more and is preferably 80 Nm or more. An upper limit of the output torque is, for example, 150 N·m. It is possible to achieve an increase in an electric current and an increase in an output of the motor 20 by adopting the configuration of the control board 50, in particular, a wiring structure including arcuate wiring sections 71 described below.

The crankshaft unit 30 includes the crankshaft 12 and tubular input bodies 31 and 32 attached to the crankshaft 12. For example, the input body 31 is fixed to the crankshaft 12 by spline coupling. The input body 32 is attached to the crankshaft 12 via the input body 31. The crankshaft 12 is disposed in the left-right direction and rotatably supported by bearings 36a and 36b. The crankshaft 12 is disposed in parallel to the motor shaft 21 further in the front of the case 40 than the motor 20.

The crankshaft unit 30 includes a tubular output body 33 to which the sprocket 13 is fixed. A one-way clutch 34 is provided between the input body 32 and the output body 33. A rotational force of the crankshaft 12 is transmitted to the sprocket 13 via the input bodies 31 and 32 and the output body 33. A claw that is urged to an outer side and touches the inner circumferential surface of the outer and is caught by teeth of the outer when the crankshaft 12 rotates in a positive direction is provided in an inner of the one-way clutch 34. In this embodiment, a part of the input body 32 may constitute the inner of the one-way clutch 34 and a part of the output body 33 may constitute the outer.

A torque sensor 35 is provided around the periphery of the input body 31. The torque sensor 35 is, for example, a magneto-striction type sensor. The input body 31 fixed to the crankshaft 12 is twisted by a stepping force on the pedals 7, and a degree of the twist changes according to the stepping force. Therefore, stepping force torque can be measured using the magneto-striction type torque sensor 35. Detection information of the torque sensor 35 is transmitted to the microcomputer 53 of the control board 50 and used for output control for the motor 20.

In this embodiment, the rotating speed of the crankshaft 12 is measured using a Hall element 62 mounted on the control board 50. The crankshaft unit 30 includes a rotating body 37a externally fitted in the input body 32, a rotating shaft 38 disposed parallel to the crankshaft 12, a rotating body 37b fixed to the one end of the rotating shaft 38 in the axial direction and engaging with the rotating body 37a, and a rotating body 39 fixed to the other end, in the axial direction, of the rotating shaft 38. The rotating bodies 37a and 37b include gears that mesh with each other. Like the rotating body 24, the rotating body 39 includes a permanent magnet and functions as a section to be detected by the Hall element 62. Since the rotating body 39 rotates together with the crankshaft 12, the Hall element 62 can measure the rotating speed of the crankshaft 12 by detecting a magnetic field of the rotating body 39.

The case 40 is a housing that houses the motor 20, the crankshaft unit 30, the speed reducing mechanism 15, and the like, and holds the motor 20, the crankshaft unit 30, the speed reducing mechanism 15, and the like. Bearings 18a and 18b that support the output shaft 16, the bearings 19a and 19b that support the motor shaft 21, and the bearings 36a and 36b that support the crankshaft 12, are attached to the case 40. The case 40 includes, for example, a first divided body 41 and a second divided body 42, and is configured to make it possible to remove the second divided body 42 from the first divided body 41 to open an internal space. The first divided body 41 constitutes a left side portion of the case 40 and houses the motor 20.

The case 40 is generally made of metal but may be made of resin. The motor 20, the speed reducing mechanism 15, the output shaft 16, a retainer 43, and the like, are housed in a rear part of the case 40. The crankshaft unit 30 and the like are housed in a front part of the case 40. The retainer 43 holds the bearings 18a and 18b. The retainer 43 functions as a partition wall that divides a space in which the speed reducing mechanism 15 is disposed and a space in which the control board 50 is disposed. The retainer 43 prevents grease and lubricant of the speed reducing mechanism 15 from scattering and adhering to the control board 50.

As described above, the control board 50 is disposed with at least a part of the control board 50 overlapping the motor 20 when viewed in the motor axial direction. The Hall element 52 is mounted in a position overlapping the rotor 22 in the motor axial direction. For example, one third or more of a substrate area of the control board 50 overlaps the motor 20 in the motor axial direction. The control board 50 is disposed in the left-right direction center of the case 40 and screwed to the first divided body 41. The control board 50 is disposed across the motor 20 and the crankshaft unit 30 in a right side view (FIG. 3) of the motor unit 10 in a state in which the second divided body 42 is removed.

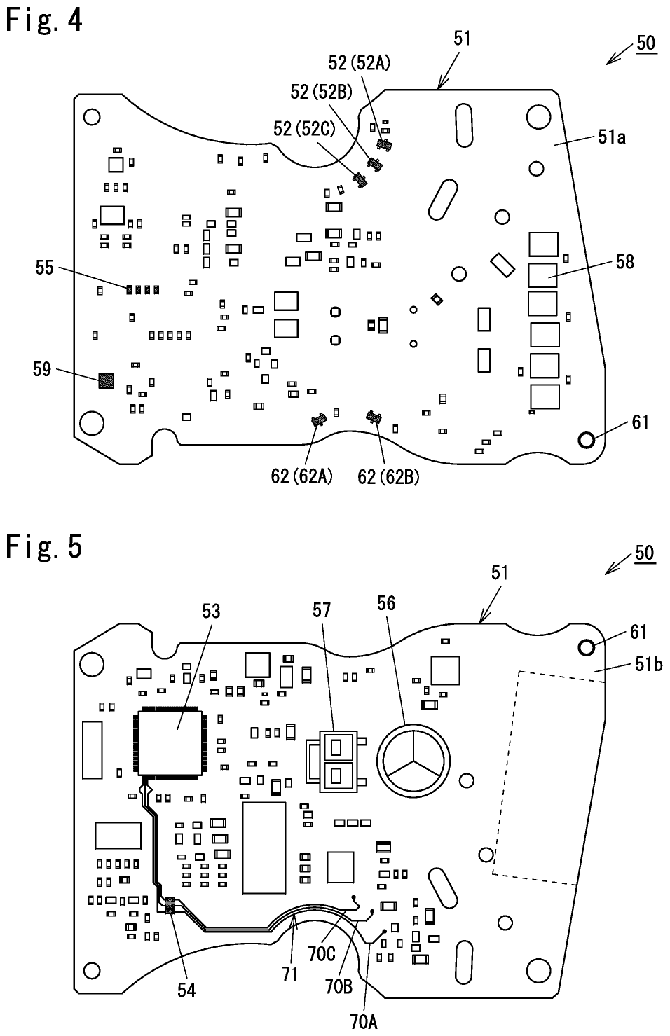

The control board 50 includes, as electronic components mounted on the substrate 51, besides the Hall elements 52 and 62 and the microcomputer 53, a switching element 58 (see FIG. 4 referred to below) that drives the motor 20, filter elements 54, and an electrolytic capacitor 56. The substrate 51 is a substantially rectangular substrate and is disposed such that the longitudinal direction of the substrate 51 extends in the up-down direction. A recess curved to surround the motor shaft 21 is formed at an end edge of the substrate 51 near the motor shaft 21. As described in detail below, on the control board 50, the microcomputer 53 is mounted on the upper end side of the substrate 51. The switching element 58 is mounted on the lower end side of the substrate 51 separated from the microcomputer 53.

The control board 50 is disposed such that, for example, the shortest distance from the gap 27 formed between the rotor 22 and the stator 23 to the control board 50 is 5 mm or more and 20 mm or less or 10 mm or more and 20 mm or less. In other words, the distance in the motor axial direction from the gap 27 to the control board 50 is set to 5 mm or more and 20 mm or less or 10 mm or more and 20 mm or less. In this case, it is possible to achieve a reduction in the size of the motor unit 10 while reducing the influence of a leakage flux on the control board 50.

A configuration of the control board 50 is described in detail below further with reference to FIGS. 4 and 5. FIG. 4 is a diagram showing a first surface 51a of the control board 50. FIG. 5 is a diagram showing a second surface 51b of the control board 50. Of the surfaces of the control board 50 (the substrate 51), a face facing the rotor 22 side is represented as “first surface 51a” and a surface on the opposite side of the first surface 51a is represented as “second surface 51b”.

As shown in FIGS. 3 to 5, the control board 50 is configured by mounting electronic components such as the Hall element 52 and the microcomputer 53 on the substrate 51. The substrate 51 is, for example, a printed wiring board obtained by forming wires that electrically connect the electronic components on the surface of an insulative resin substrate. The substrate 51 may have a multilayer structure, or some of the wires may be formed in an inner layer of the substrate 51. The substrate 51 includes, as one of the wires, a signal line 70 that connects the Hall element 52 and the microcomputer 53.

The Hall elements 52 and 62, filter elements 55, the switching element 58, an inertial sensor 59, and the like are mounted on the first surface 51a of the substrate 51. An example of the switching element 58 is a field effect transistor (FET). The switching element 58 is driven based on a control signal output from the microcomputer 53. As a result, output of the motor 20 is controlled. Examples of the inertial sensor 59 include an acceleration sensor, a six-axis acceleration sensor, an inclination sensor, and a gyro sensor. At least one of these sensors is provided on the control board 50 as the inertial sensor 59. Detection information of the inertial sensor 59 is transmitted to the microcomputer 53 and used for output control for the motor 20.

The microcomputer 53, the filter elements 54, the electrolytic capacitor 56, a power supply connector 57, and the like are mounted on the second surface 51b of the substrate 51. The electrolytic capacitor 56 has a function of smoothing an input voltage. In order to sufficiently exert a smoothing effect of the electrolytic capacitor 56, the electrolytic capacitor 56 is preferably disposed near a power supply system such as the switching element 58, and the length of a wire that connects the electrolytic capacitor 56 and the switching element 58 is preferably reduced. A cable leading to the battery 11 is connected to the power supply connector 57.

The Hall element 52 is a sensor that detects a magnetic field of the rotating body 24 that rotates together with the motor shaft 21. Therefore, the Hall element 52 is preferably mounted on the first surface 51a on a side close to the rotating body 24. Similarly, the Hall element 62 is preferably mounted on the first surface 51a on the side close to the rotating body 39. On the other hand, the microcomputer 53 is preferably mounted on the second surface 51b. Occurrence of magnetic field noise in the microcomputer 53 can be suppressed by disposing the microcomputer 53 on the second surface 51b on a side far from the rotor 22, the stator 23, and the rotating body 24, which are sources of magnetic field noise. Similarly, the signal line 70 that connects the Hall element 52 and the microcomputer 53 is preferably formed on the second surface 51b.

Since the Hall element 52 is disposed on the first surface 51a of the substrate 51 and the microcomputer 53 and the signal line 70 are disposed on the second surface 51b, a conductive path that pierces through the substrate 51 in the thickness direction and connects the Hall element 52 and the signal line 70 is formed on the control board 50. The signal line 70 may be formed on both the surfaces of the substrate 51. In this case, a conductive path that pierces through the substrate 51 in the thickness direction and connects the signal lines 70 on the surfaces may be formed.

As described above, the microcomputer 53 is a control element that controls the motor 20 using detection information of the torque sensor 35, the Hall element 52, the inertial sensor 59, and the like. The microcomputer 53 includes, for example, a processor, a memory, and an input/output interface. The processor is constituted by, for example, a CPU. The processor reads and executes a control program for the power-assisted bicycle 1 to thereby control output of the motor 20 and realize an appropriate assist function. The memory includes a nonvolatile memory such as a ROM, a HDD, or an SSD that store the control program and the like, and a volatile memory such as a RAM.

On the second surface 51b of the substrate 51, the microcomputer 53 is preferably mounted further out in the radial direction of the motor 20 than the inner circumferential edge (the gap 27) of the stator 23, and more preferably mounted in a position not overlapping the motor 20 in the motor axial direction. Similarly, the inertial sensor 59 is preferably mounted in a position not overlapping the motor 20 in the motor axial direction on the first surface 51a of the substrate 51. In this case, it is possible to suppress occurrence of magnetic field noise due to the motor 20 in a control signal system such as the microcomputer 53 and the inertial sensor 59. It is possible to use, for example, a microcomputer, a sensor, and the like that have low magnetic field noise resistance and are inexpensive.

The microcomputer 53 and the inertial sensor 59 are mounted on one side (the upper side), in the longitudinal direction of the substrate 51. The switching element 58 is mounted on other side (the lower side), in the longitudinal direction, of the substrate 51. That is, the control signal system such as the microcomputer 53 and the inertial sensor 59 and the power supply system such as the switching element 58 are disposed at positions separated from each other as much as possible on the substrate 51. In this case, it is possible to suppress, in the control signal system, occurrence of magnetic field noise due to the power supply system.

The control board 50 includes a cable 60 for supplying electric power to the coil of the stator 23 (see FIG. 3). In this embodiment, three cables 60 are provided to correspond to the three-phase coils of the U phase, the V phase, and the W phase.

As described above, the control board 50 is screwed to the first divided body 41 of the case 40. A conductive layer is formed at the circumferential edge of a screw hole 61 formed in the substrate 51. A ground is formed by the conductive layer and a conductive screw. A ground line including a capacitor is connected to the conductive layer at the circumferential edge of the screw hole 61. The ground is preferably disposed near a power supply system line. In this embodiment, the ground is provided at the lower front end of the control board 50.

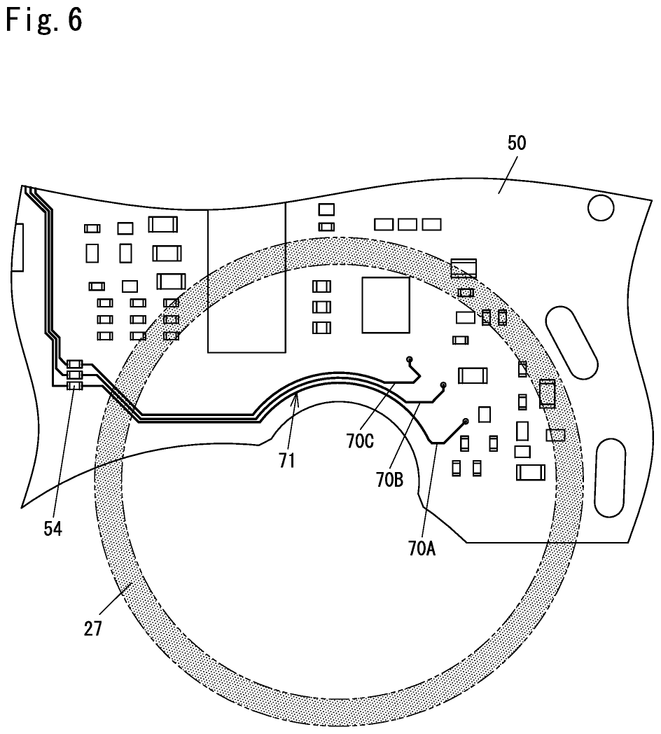

The Hall element 52, the filter elements 54 and 55, and the signal line 70 are described in further detail below, with reference to FIGS. 6 and 7A and 7B. FIGS. 6 and 7A and 7B are diagrams for describing a configuration of the signal line 70 in correlation with the motor 20. In FIG. 6, the gap 27 of the motor 20 is shown. FIG. 7B extracts and shows the signal line 70 that traverses the gap 27 shown in FIG. 7A.

As shown in FIGS. 4 to 7, the control board 50 includes a plurality of Hall elements 52A, 52B, and 52C and a plurality of signal lines 70 that connect the Hall elements and the microcomputer 53. On the control board 50, signal lines 70A, 70B, and 70C are formed to correspond to the Hall elements 52A, 52B, and 52C. As described above, the filter elements 54 and 55 are mounted on the control board 50. The filter elements 54 and 55 are connected to the signal lines 70 and process detection signals of the Hall elements 52. The filter elements 54 and 55 are connected to each of the signal lines 70A, 70B, and 70C.

The Hall elements 52 are elements that detect a magnetic field using a Hall effect and are mounted in a position overlapping the rotating body 24 in the motor axial direction on the first surface 51a of the substrate 51 to be able to detect a magnetic field of the rotating body 24. When the motor 20 is a three-phase brushless DC motor, the Hall elements 52 can detect a magnetic pole position of the rotor 22 by detecting a magnetic field of the rotating body 24 that rotates together with the rotor 22. For example, the microcomputer 53 feedback-controls the switching element 58 based on the magnetic pole position of the rotor 22 and executes output control for the motor 20.

Elements of the same type can be used as the Hall elements 52A, 52B, and 52C. The Hall elements 52A, 52B, and 52C are disposed in the motor circumferential direction and preferably disposed on an arc centering on a shaft core 21x of the motor shaft 21. In this case, the Hall elements 52A, 52B, and 52C can accurately detect a magnetic field of the rotating body 24. The Hall elements 52A, 52B, and 52C are disposed at equal intervals on the arc centering on the shaft core 21x of the motor shaft 21. Note that, similarly, a plurality of Hall elements 62 for measuring the rotating speed of the crankshaft 12 are disposed on an arc centering on the rotating shaft 38. In this embodiment, two Hall elements 62A and 62B are disposed.

An example of the filter elements 54 and 55 is an RC low-pass filter configured by a resistor and a capacitor. The filter elements 54 and 55 perform signal processing for cutting a high-frequency component of a detection signal of the Hall elements 52. The filter elements 54 are disposed further out in the radial direction of the motor 20 than the gap 27 of the motor 20 on the second surface 51b of the substrate 51. The filter elements 55 are disposed further out in the radial direction of the motor 20 than the filter elements 54 on the first surface 51a of the substrate 51. That is, the filter elements 54 and 55 may be mounted at positions overlapping the stator 23 in the motor axial direction but are preferably mounted at positions not overlapping the rotor 22 and the gap 27 in the motor axial direction. In this case, it is possible to reduce the influence of a leakage flux of the motor 20 on the filter elements 54 and 55.

The signal lines 70 include arcuate wiring sections 71 curved to be convex to the radial direction outer side of a circle centering on the shaft core of the motor shaft 21. There are as many signal lines 70 as there are Hall elements 52. Each of the signal lines 70A, 70B, and 70C includes the arcuate wiring section 71. Ground wires 72 of the Hall elements 52 are formed on the control board 50. A wiring loop is formed by the signal lines 70 and the ground wires 72. A leakage flux of the motor 20 pierces through the wiring loop. Consequently, it is assumed that an electromotive voltage is generated among the signal lines, and noise is superimposed on detection signals of the Hall elements 52 that propagate in the signal lines 70. However, it is possible to greatly reduce the influence of the leakage flux by providing the arcuate wiring sections 71.

As described above, the directions of the magnetic fluxes between the rotor 22 and the teeth 25 of the stator 23 are opposite, for example, between the teeth 25 that are adjacent to each other in the rotor circumferential direction. Accordingly, the arcuate wiring sections 71 are provided to allow a plurality of magnetic flues to pierce through the wiring loop. Consequently, an offset effect for adjacent magnetic fluxes is obtained, and magnetic field noise that occurs in the signal lines 70 is suppressed. That is, the arcuate wiring sections 71 have a function of cancelling magnetic field noise that affects detection signals of the Hall elements 52.

The arcuate wiring sections 71 of the signal lines are disposed side by side in the radial direction of the motor 20. An interval between the arcuate wiring sections 71 that are adjacent to each other in the motor radial direction is preferably small, in a range in which the arcuate wiring sections 71 do not electrically come into contact. Specifically, the interval is preferably 0.30 mm or less and more preferably 0.25 mm or less. As a result of studies by the inventors, it has been found that occurrence of magnetic field noise can be more effectively suppressed if the interval between the arcuate wiring sections 71 is set to 0.30 mm or less. Note that the end edge of the substrate 51 near the motor shaft 21 is curved along the motor circumferential direction. The arcuate wiring sections 71 are formed to extend along the curved end edge of the substrate 51.

The arcuate wiring sections 71 are formed in a region overlapping the rotor 22 and the rotating body 24 in the motor axial direction. In this embodiment, the diameter of the rotating body 24 is smaller than the diameter of the rotor 22 and the rotating body 24 is disposed nearer the control board 50 than the rotor 22. The arcuate wiring sections 71 may be formed only in a region overlapping the rotating body 24 in the motor axial direction. The signal lines 70 may be linearly formed in a region overlapping the rotor 22 and not overlapping the rotating body 24.

The signal lines 70 are formed on the second surface 51b of the substrate 51 facing the opposite side of the rotor 22 at least in a region overlapping the gap 27 of the motor 20 in the motor axial direction. When the substrate 51 has a multilayer structure, the signal lines 70 may be formed in the inner layer of the substrate 51. That is, the signal lines 70 are preferably formed other than on the first surface 51a near the rotor 22 in a region overlapping at least the signal lines 70 in the motor axial direction. Since a leakage flux of the motor 20 particularly easily occurs from the gap 27, an effect of suppressing magnetic field noise is improved by disposing the signal lines 70 on the second surface 51b.

Further, the signal lines 70 are connected to the microcomputer 53 on the second surface 51b of the substrate 51. The arcuate wiring sections 71 of the signal lines 70 are also formed on the second surface 51b. When the substrate 51 has the multilayer structure, the arcuate wiring sections 71 may be formed in the inner layer of the substrate 51. In this embodiment, all of the signal lines 70 including the arcuate wiring sections 71 are formed on the second surface 51b. It is possible to more effectively suppress occurrence of magnetic field noise in the signal lines 70 by disposing the signal lines 70 on the second surface 51b on a side far from the rotor 22, the stator 23, the rotating body 24, and the gap 27, which are sources of magnetic field noise.

As shown in FIGS. 6 and 7, the arcuate wiring sections 71 of the signal lines 70A, 70B, and 70C extend in the motor circumferential direction. The arcuate wiring sections 71 are disposed in an arcuate shape centering on the shaft core 21x of the motor shaft 21. In this case, magnetic field noise that occurs in the signal lines 70 is more effectively suppressed. The Hall elements 52A, 52B, and 52C are more distant from the microcomputer 53 in this order. The arcuate wiring section 71 of the signal line 70A is the longest and the arcuate wiring section 71 of the signal line 70C is the shortest. In a portion where the arcuate wiring sections 71 are disposed side by side in the motor radial direction, the arcuate wiring sections 71 are disposed parallel to one another at an interval (for example, 0.3 mm or less).

When the control board 50 is viewed in the motor axial direction, at least one of the arcuate wiring sections 71 are preferably formed to opposite to the three teeth 25 that are adjacent to one another in the motor circumferential direction. That is, when the control board 50 is viewed in the motor axial direction, at least one arcuate wiring section 71 is formed to pass positions opposite to the adjacent three teeth 25. In other words, one arcuate wiring section 71 extending in the motor circumferential direction is present on the motor radial direction inner side of the adjacent three teeth 25. In an example shown in FIG. 7A, the arcuate wiring sections 71 of the signal lines 70A are formed to pass positions opposite to the adjacent three teeth 25. Note that all the arcuate wiring sections 71 may be formed to opposite to the adjacent three teeth 25.

If the signal lines 70 include the arcuate wiring sections 71, an effect of suppressing magnetic field noise by offsetting adjacent magnetic fluxes can be obtained regardless of whether the arcuate wiring sections 71 are long or short. However, when the arcuate wiring sections 71 are formed to opposite to the adjacent three teeth 25, the noise suppressing effect is more conspicuous. In this embodiment, since the three-phase motor is applied to the motor 20, strictly speaking, the directions of vectors of magnetic fluxes are opposite in the three teeth 25 adjacent to one another in the motor circumferential direction. Therefore, the offset of the adjacent magnetic fluxes more effectively appears and the noise suppressing effect is more conspicuous.

The signal lines 70 preferably traverse, at a short length, a region overlapping the gap 27 of the motor 20 in the motor axial direction. Specifically, as shown in FIG. 7B, when the control board 50 is viewed in the motor axial direction, the signal lines 70 preferably traverse the gap 27 such that an imaginary line connecting a point X where the signal lines 70 overlap the inner circumferential edge of the stator 23 and a point Y where the signal lines 70 overlap the outer circumferential edge of the rotor 22 has an angle of 45° or less with respect to an imaginary line Z passing the point Y and the shaft core 21x of the motor shaft 21. An angle θ shown in FIG. 7B is more preferably 30° or less, or 20° or less, and may be substantially 0°. It is possible to more effectively reduce the influence of a leakage flux by setting the length of the signal lines 70 traversing the gap 27 in which a leakage flux easily occurs as short as possible. When the angle θ is 45° or less, the noise suppressing effect is particularly conspicuous.

In an example shown in FIG. 7B, portions of the signal lines 70 traversing the gap 27 are linearly formed without curving. That is, when the control board 50 is viewed in the motor axial direction, the signal lines 70 traverse the gap 27 at the angle θ with respect to the imaginary line Z. Note that if an angle of an imaginary line passing the point X and the point Y with respect to the imaginary line Z is 45° or less, the signal line 70 may be slightly curved on the gap 27. In each of the signal lines 70A, 70B, and 70C, portions traversing the gap 27 are disposed parallel to one another, for example, at an interval of 0.3 mm or less.

Further, the signal lines 70 are preferably disposed to overlap the slot 26, which is the gap between the teeth 25 that are adjacent to each other, in the motor axial direction. The signal lines 70 are connected to the microcomputer 53 mounted on the outer side of the motor 20 through a region overlapping the stator 23 in the motor axial direction, but are formed to pass a region overlapping the slot 26 as much as possible, in the region overlapping the stator 23 in the motor axial direction. In this case, it is possible to more effectively reduce the influence of a leakage flux. Portions of the signal lines 70 formed in the region overlapping the stator 23 in the motor axial direction are preferably set to have a length traversing the slot 26 that is larger than a length traversing the teeth 25.

As described above, with the motor unit 10 including the configuration described above, it is possible to reduce the influence of a leakage flux of the motor 20 and suppress noise that occurs in the signal lines 70 of the control board 50. With the configuration of the control board 50, it is possible to effectively suppress magnetic field noise in other control signal systems such as the microcomputer 53, the filter elements 54 and 55, and the inertial sensor 59. Accordingly, the power-assisted bicycle 1 including the motor unit 10 has, for example, controllability of the motor 20, and has a satisfactory assist function.

Note that the embodiment described above can be changed in design as appropriate in a range in which the advantage of the present disclosure is not lost. For example, in the embodiment described above, the configuration in which the magnetic field of the rotating body 24 rotating together with the motor shaft 21 is detected by the Hall elements 52 is illustrated. However, the Hall elements 52 may be configured to detect a magnetic field of the motor shaft 21 or the rotor 22. In this case, the motor 20 may not include the rotating body 24.

As the sensor that detects a magnetic field of the motor shaft, the rotor, or the rotating body rotating together with the motor shaft, for example, a magnetoresistance effect element (an MR sensor) may be used instead of the Hall elements 52. At least one MR sensor is mounted in a position overlapping the rotor in the motor axial direction on the first surface facing the rotor side of the control board.

### REFERENCE SIGNS LIST

1 Power-assisted bicycle, 2 Frame, 2a Head pipe, 2b Front fork, 2c Down pipe, 2d Seat pipe, 2e Chain stay, 2f Seat stay, 3a Front wheel, 3b Rear wheel, 4 Handlebar, 5 Saddle, 6 Crankarm, 7 Pedal, 8 Chain, 9, Headlight, 10 Motor unit, 11 Battery, 12 Crankshaft, 13, 14 Sprocket, 15 Speed reducing mechanism, 16 Output shaft, 17, 34 One-way clutch, 18a, 18b, 19a, 19b, 36a, 36b Bearing, 20 Motor, 21 Motor shaft, 21x Shaft core, 22 Rotor, 23 Stator, 24, 37a, 37b, 39 Rotating body, 25 Teeth, 26 Slot, 27 Gap, 30 Crankshaft unit, 31, 32 Input body, 33 Output body, 35 Torque sensor, 38 Rotating shaft, 40 Case, 41 First divided body, 42 Second divided body, 43 Retainer, 50 Control board, 51 Substrate, 51a First surface, 51b Second surface, 52, 52A, 52B, 52C, 62, 62A, 62B Hall element, 53 Microcomputer, 54, 55 Filter element, 56 Electrolytic capacitor, 57 Power supply connector, 58 Switching element, 59 Inertial sensor, 60 Wire, 61 Screw hole, 70, 70A, 70B, 70C Signal lines, 71 Arcuate wiring section, 72 Ground wire

1. A motor unit comprising:
a motor including a motor shaft, a rotor fixed to the motor shaft, and a stator; and
a control board on which a sensor that detects a magnetic field of the motor shaft, the rotor, or a rotating body rotating together with the motor shaft, and a control element that controls the motor using detection information of the sensor, are mounted, the control board being disposed with at least a part of the control board overlapping the motor when viewed in a motor axial direction, wherein
the sensor is disposed to overlap the rotor when viewed in the motor axial direction,
the control element is disposed further out in a radial direction of the motor than an inner circumferential edge of the stator surrounding the rotor,
the control board includes a signal line that connects the sensor and the control element, and
when the control board is viewed in the motor axial direction, the signal line traverses a gap formed between the rotor and the stator such that a first imaginary line connecting a first point where the signal line overlaps an outer circumferential edge of the rotor, and a second point where the signal line overlaps the inner circumferential edge of the stator, has an angle of 45° or less with respect to a second imaginary line passing through the first point and the shaft core of the motor shaft.

2. The motor unit according to claim 1, wherein
the signal line includes an arcuate wiring section bent to be convex in a radial direction outer side of a circle centering on a shaft core of the motor shaft.

3. The motor unit according to claim 2, wherein the arcuate wiring section extends in a motor circumferential direction.

4. The motor unit according to claim 2, wherein the arcuate wiring section is disposed in an arcuate shape centering on the shaft core of the motor shaft.

5. The motor unit according to claim 1, wherein
the stator includes a plurality of teeth disposed side by side in a motor circumferential direction, and
the signal line is disposed to overlap, in the motor axial direction, a gap between the teeth that are adjacent to each other.

6. The motor unit according to claim 2, wherein
the motor is a three-phase motor, and
the arcuate wiring section is formed to opposite to a trio of the teeth adjacent to one another in a motor circumferential direction when the control board is viewed in the motor axial direction.

7. The motor unit according to claim 1, wherein the sensor is configured by at least one magnetoresistance effect element.

8. The motor unit according to claim 1, wherein the sensor is configured by a plurality of Hall elements.

9. The motor unit according to claim 8, wherein the plurality of Hall elements are disposed on an arc centering on the shaft core of the motor shaft.

10. The motor unit according to claim 8, wherein
a plurality of the signal lines numbering as many as the plurality of Hall elements are formed, and each of the signal lines includes an arcuate wiring section bent to be convex in a radial direction outer side of a circle centering on a shaft core of the motor shaft, and
a plurality of the arcuate wiring sections are disposed side by side in a motor radial direction.

11. The motor unit according to claim 10, wherein an interval between the arcuate wiring sections that are adjacent to each other in the motor radial direction is 0.3 mm or less.

12. The motor unit according to claim 1, wherein
a filter element is mounted on the control board, and
the filter element is disposed further out in a radial direction of the motor than a gap formed between the rotor and the stator.

13. The motor unit according to claim 1, wherein, at least in a region overlapping, in the motor axial direction, a gap formed between the rotor and the stator, the signal line is disposed on a second surface on an opposite side of a first surface facing the rotor side of the control board, or in an inner layer of the control board.

14. The motor unit according to claim 2, wherein the arcuate wiring section is disposed on a second surface on an opposite side of a first surface facing the rotor side of the control board, or in an inner layer of the control board.

15. The motor unit according to claim 13, wherein the signal line is connected to the control element on the second surface of the control board.

16. The motor unit according to claim 1, wherein a shortest distance from a gap formed between the rotor and the stator to the control board is 5 mm or more and 20 mm or less.

17. The motor unit according to claim 1, wherein the control board is disposed such that one third or more of a substrate area overlaps the motor in the motor axial direction.

18. The motor unit according to claim 1, wherein the control element is mounted in a position not overlapping the motor in the motor axial direction on the control board.

19. The motor unit according to claim 1, wherein
a switching element that drives the motor is mounted on the control board, and
the control element is disposed on a first end of the control board, and the switching element is disposed on a second end of the control board on an opposite side of the first end.

20. The motor unit according to claim 19, wherein
an inertial sensor is mounted on the control board, and
the inertial sensor is mounted in a position not overlapping the motor in the motor axial direction on one end of the control board.

21. The motor unit according to claim 1, wherein a maximum value of a driving current of the motor is 15 A or more.

22. The motor unit according to claim 1, wherein a maximum value of output torque of the motor is 75 Nm or more.

23. A power-assisted bicycle comprising the motor unit according to claim 1.
